(19) United States
(12) Patent Application Publication
(10) Pub. No.: US 2026/0035532 A1
(43) Pub. Date: Feb. 5, 2026

(54) DECOMPOSITION METHOD AND DECOMPOSITION APPARATUS FOR RESIN

(71) Applicants: THE JAPAN STEEL WORKS, LTD., Shinagawa-ku, Tokyo (JP); HONDA MOTOR CO., LTD., Minato-ku, Tokyo (JP)

(72) Inventors: Tessei IMAIDA, Tokyo (JP); Daigo SAGA, Tokyo (JP); Hiroshi UNEDA, Tokyo (JP); Tsuyoshi BABA, Saitama (JP); Shoko HIRAOKA, Saitama (JP); Satoshi OZAKI, Saitama (JP)

(21) Appl. No.: 19/101,211

(22) PCT Filed: Apr. 20, 2023
(86) PCT No.: PCT/JP2023/015796

§ 371 Date: Feb. 4, 2025

(30) Foreign Application Priority Data
Aug. 8, 2022 (JP) 2022-126495

(51) Int. Cl. C08J 11/10; B01J 3/00; B01J 3/02

(52) U.S. Cl. CPC C08J 11/10; B01J 3/002; B01J 3/008; B01J 3/02; C08J 2377/00

(57) ABSTRACT

A decomposition method and a decomposition apparatus for resin capable of safely and efficiently decomposing a resin are provided. A decomposition apparatus for resin 10 includes: a cylinder 12; a resin supplier 11 supplying a thermoplastic resin to the cylinder 12; a screw 12a transporting the supplied thermoplastic resin and a melt-plasticized thermoplastic resin; a fluid supplier 13 supplying a heated and pressurized fluid into the cylinder in order to decompose the melt-plasticized thermoplastic resin in a subcritical state or a supercritical state; an extruder 14 provided at a tip of the cylinder 12 and discharging a decomposed product of the thermoplastic resin to outside of the cylinder; a rotary drive mechanism 15 rotationally driving the screw 12a; and a backflow suppression mechanism 16 suppressing backflow of the melt-plasticized thermoplastic resin in the cylinder 12.

### TECHNICAL FIELD

The present invention relates to a decomposition method and a decomposition apparatus for resin, and particularly relates to a decomposition method and a decomposition apparatus for resin configured to prevent backflow to a resin supplier side when the resin is decomposed under high temperature and high pressure conditions.

### BACKGROUND ART

Currently, plastic products are used in a very wide range of fields, and a use amount of the plastic products is enormous. On the other hand, the disposal of the plastic products costs money, and there is a problem of their influence on environment due to the flow of their components into rivers, seas and the like, when, for example, they are left in the natural environment.

For this reason, effective use of various resins as resources by recycling has been variously studied, and a method of, for example, collecting and reusing monomers obtained by thermally decomposing acrylic resin under use of a twin-screw extruder has been known (see, for example, Patent Document 1).

Also, in recent years, a method of obtaining monomers by exposing such a resin to a fluid of a subcritical state or a supercritical state has also been studied as a decomposition method for resin.

### RELATED ART DOCUMENT

### Patent Document

Patent Document 1: Japanese Patent Application Laid-open

Publication No. H11 (1999)-106427

### SUMMARY OF THE INVENTION

### Problems to be Solved by the Invention

Incidentally, under use of the subcritical state or the supercritical state, predetermined temperature and pressure need to be set depending on the liquid (fluid) to be used. Since the conditions are usually high temperature and high pressure, a sealed apparatus or the like is considered as a decomposition apparatus used for such applications.

On the other hand, to prepare a decomposition apparatus durable against such a subcritical state or a supercritical state, it initially costs much since, for example, a dedicated apparatus must be fabricated, and a total processing cost is made high.

Accordingly, an object of the present invention is to provide a decomposition method and a decomposition apparatus for resin being capable of safely and continuously decomposing a resin in order to promote the recycling of the resin as described above.

### Means for Solving the Problems

A decomposition method for resin disclosed in the present application includes: a step (a) of supplying a thermoplastic resin from a resin supplier to a cylinder; a step (b) of heating and pressurizing and then melt-plasticizing the supplied thermoplastic resin in the cylinder; a step (c) of supplying a heated and pressurized fluid from a fluid supplier to the melt-plasticized thermoplastic resin and mixing the fluid with the thermoplastic resin; a step (d) of decomposing the melt-plasticized thermoplastic resin by exposing the melt-plasticized thermoplastic resin to a subcritical state or a supercritical state by the supplied fluid; and a step (e) of extruding a decomposed product of the thermoplastic resin obtained in the step (d) from an extruder provided at a tip of the cylinder.

Here, in the step (b) in this decomposition method, a backflow suppression step is performed, this step measuring at least one selected from a temperature of the thermoplastic resin, a pressure of the thermoplastic resin and a temperature of the cylinder, and then, suppressing the backflow of the melt-plasticized t hermoplastic resin in accordance with the measured value.

A decomposition apparatus for resin disclosed in the present application includes: a cylinder; a resin supplier supplying a thermoplastic resin to be decomposed, to the cylinder; a screw transporting the supplied thermoplastic resin and a melt-plasticized thermoplastic resin in the cylinder; a fluid supplier supplying a heated and pressurized fluid into the cylinder in order to decompose the melt-plasticized thermoplastic resin in a subcritical state or a supercritical state; and an extruder provided at a tip of the cylinder and extruding a decomposed product of the thermoplastic resin to outside of the cylinder.

### Effects of the Invention

Furthermore, this decomposition apparatus includes, in the cylinder provided between the resin supplier and the fluid supplier, at least one selected from a resin thermometer for measuring a temperature of the thermoplastic resin, a resin pressure gauge for measuring a pressure of the thermoplastic resin, a cylinder thermometer for measuring a temperature of the cylinder, and a screw measuring meter for measuring an energy consumption or drive torque of a rotary drive mechanism driving the screw, and has a backflow suppression mechanism suppressing the backflow of the melt-plasticized thermoplastic resin in accordance with the change in at least one of the measured values of the resin thermometer, the resin pressure gauge, the cylinder thermometer, and the screw measuring meter.

According to a decomposition method and a decomposition apparatus for resin disclosed in the present application, a decomposition method and a decomposition apparatus for resin capable of safely and continuously decomposing the resin can be provided.

### BRIEF DESCRIPTIONS OF THE DRAWINGS

FIG. 1 is a side view showing a schematic configuration of a decomposition apparatus for resin in a first embodiment.

FIG. 2 is diagram in a side view for explaining a screw disposed in a cylinder of the decomposition apparatus of FIG. 1.

FIG. 3 is a diagram for explaining a backflow suppression mechanism of the decomposition apparatus of FIG. 1 in more detail.

FIG. 4 is a diagram for explaining a backflow suppression mechanism of the decomposition apparatus of FIG. 1 in more detail.

FIG. 5 is a flowchart for explaining an operation of the decomposition apparatus for resin in the first embodiment.

FIG. 6 is a side view showing a schematic configuration of a decomposition apparatus for resin in a second embodiment.

FIG. 7 is a flowchart for explaining an operation of the decomposition apparatus for resin in the second embodiment.

FIG. 8 is a side view showing a schematic configuration of a decomposition apparatus for resin in a third embodiment.

FIG. 9 is a flowchart for explaining an operation of the decomposition apparatus for resin in the third embodiment.

### DETAILED DESCRIPTION OF PREFERRED EMBODIMENTS

Hereinafter, embodiments will be described in detail with reference to examples and drawings. Note that components having the same function are denoted by the same or similar reference symbols throughout all the drawings for describing the embodiments, and the repetitive description thereof will be omitted.

### Background of Study

First, the background of the study of the present application will be explained. For the decomposition (depolymerization) of the resin by the fluid of the subcritical state or the supercritical state as described above, a sealed process container durable against the process conditions is generally prepared. However, for the decomposition of resin, the present inventors have studied a possibility of use of a resin extruder used for forming resin materials.

That is, the present inventors have considered a possibility that the resin can be continuously and efficiently decomposed by using such a resin extruder, without preparing a special process apparatus for the decomposition of resin but with using an existing extruder that remains unchanged or with slight modifications suitable for the decomposition.

In the extruder, generally, the thermoplastic resin as a raw material is supplied from one end of a tubular cylinder, and is gradually heated and kneaded in the cylinder, and then, the melt-plasticized resin is transported by a screw. Then, the melt-plasticized resin is sufficiently kneaded during the transportation in the cylinder, and is extruded as a uniformly mixed resin material from a die provided at a tip of the cylinder. An inner condition of the cylinder is a heated and pressurized condition, and therefore, even in the decomposition of resin, it has been assumed that the decomposition can be performed under use of the apparatus that remains unchanged by mixing the resin with the fluid of the subcritical state or the supercritical state in the cylinder.

As an actual result of the decomposition of resin under such conditions tried by the present inventors, it was confirmed that the subcritical state can be maintained in the cylinder and that the resin can be also decomposed.

However, continuation of this decomposition often caused backflow and spout of the melt-plasticized resin and the not-melted resin as yet from the resin supplier of the extruder. It is thought that this is because the resin supplier side of the extruder is usually not closed and is exposed to the atmosphere, and therefore, the pressure of the melt-plasticized molten resin in the cylinder becomes larger than the pressure of the not-melted resin as yet on the resin supplier side.

Accordingly, the present inventors have variously studied to provide a decomposition apparatus that can safely and continuously decompose the resin without occurrence of the backflow of the melt-plasticized resin even in the decomposition of resin in the subcritical state under the use of the extruder, and the present inventors have found a decomposition method and a decomposition apparatus for resin that can suppress the occurrence of the backflow. The decomposition method and the decomposition apparatus for resin in the present embodiment will be explained in detail below.

### First Embodiment

### Decomposition Apparatus for Resin

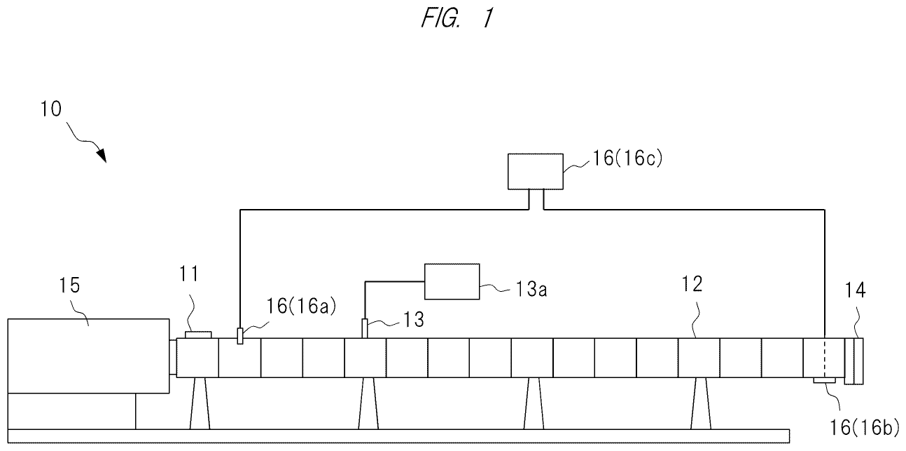

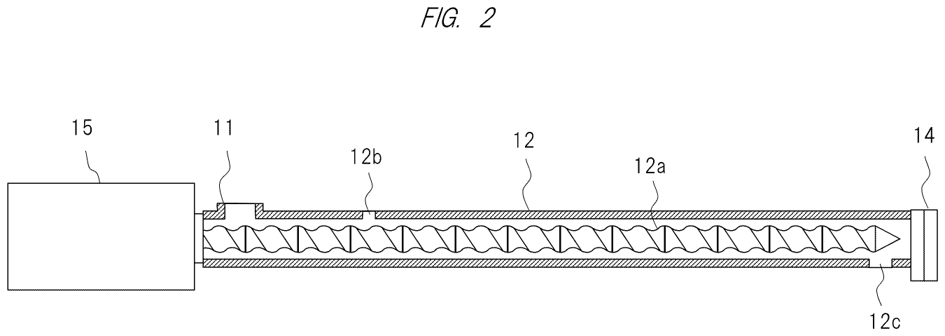

FIG. 1 is a diagram showing a configuration example of a decomposition apparatus for resin in the first embodiment. FIG. 2 is a diagram in a side view for explaining a screw disposed in a cylinder of the decomposition apparatus for resin shown in FIG. 1.

A decomposition apparatus for resin 10 shown in FIG. 1 is an apparatus used to decompose a resin to be decomposed by exposing the resin to a fluid of a subcritical state or a supercritical state.

The decomposition apparatus for resin 10 includes a resin supplier 11, a cylinder 12 with a screw, a fluid supplier 13 supplying a fluid to the cylinder 12, an extruder 14, a rotary drive mechanism 15 driving the screw of the cylinder 12, and a backflow suppression mechanism 16.

The resin supplier 11 supplies the resin to be decomposed to the cylinder 12. In the present embodiment, a thermoplastic resin is supplied as the resin to be decomposed. The thermoplastic resin to be used and supplied is of a various form such as a pellet, powder, and a flake, and is fed from above into the resin supplier 11 including a hopper by, for example, a feeder or the like, and is supplied into the cylinder 12. A case of the pellet as the thermoplastic resin to be supplied will be exemplified and explained below.

The cylinder 12 includes a screw 12a inside. FIG. 2 is a diagram in a cross-sectional view of the cylinder 12 so that the internal structure of the cylinder 12 of the decomposition apparatus for resin 10 in FIG. 1 is viewable. In the cylinder 12 in FIG. 2, a fluid supply hole 12b where the fluid supplier 13 is disposed and a relief hole 12c capable of discharging the melt-plasticized thermoplastic resin from the inside of the cylinder 12 to outside are also illustrated.

By rotating the screw 12a, the supplied resin is gradually transported inside the cylinder 12 toward the extruder 14 (downstream side). A twin-screw extruder can be configured by using a twin screw having two screws as the screw 12a. The twin-screw extruder has the flexibility to freely change operating conditions such as a screw rotation speed and a barrel setting temperature, and also has various advantages such as high transportability and continuous processability.

The cylinder 12 is made of, for example, connection of a plurality of cylinder blocks, and each cylinder block includes a space through which the thermoplastic resin can be transported. The screw 12a is provided in this space, and the screw 12a is connected to the rotary drive mechanism 15. The screw 12a is rotated by the rotary drive mechanism 15 to transport the resin to be decomposed in the cylinder 12.

Also, the cylinder 12 is provided with a heater so that its temperature can be adjusted. During the transportation of the thermoplastic resin to be decomposed from the resin supplier 11 toward the extruder 14, the thermoplastic resin is gradually heated by the above-described heater, thereby easily providing the melt-plasticized thermoplastic resin. Also, the melt-plasticized thermoplastic resin provided as described above can easily be transported in the cylinder 12 and is further transported toward the downstream side.

Also, the molten resin in the cylinder 12 and the fluid supplied from the fluid supplier 13 are pressurized by the screw 12a to reach the subcritical state or the supercritical state.

By supply of the fluid from the fluid supplier 13 described later during the process, the melt-plasticized thermoplastic resin and the fluid are mixed, and at this time, the inside of the cylinder 12 is adjusted to predetermined temperature and pressure by the heater and the screw provided in the cylinder 12 as described above, and therefore, the subcritical state or the supercritical state is achieved. Then, during further transportation in the cylinder 12 in the subcritical state or supercritical state, the decomposition of the thermoplastic resin is advanced.

The fluid supplier 13 supplies the heated and pressurized fluid to the melt-plasticized thermoplastic resin in the cylinder 12. The fluid supplier 13 is disposed so that the thermoplastic resin is melt-plasticized in the cylinder 12 and then is supplied into the cylinder 12.

By the fluid supplied from the fluid supplier 13, on its downstream side, the melt-plasticized thermoplastic resin is decomposed when being exposed to the fluid of the subcritical state or the supercritical state. Note that it is only necessary that the subcritical state or the supercritical state of the fluid supplied from the fluid supplier 13 is achieved in the cylinder 12, and the fluid does not need to be of the subcritical state or the supercritical state immediately before being supplied to the cylinder 12. However, if the fluid to be supplied is put into the subcritical state or the supercritical state before being supplied to the cylinder 12 and then is supplied into the cylinder 12 while maintaining this state, the decomposition of the melt-plasticized thermoplastic resin starts immediately after the fluid is supplied, and therefore, this state is preferable.

The fluid is added to the melt-plasticized thermoplastic resin as described above. Since the inside of the cylinder 12 at the time of the addition is heated and pressurized, the fluid supplied at this time is supplied into the cylinder 12 while being against the pressure.

Also, since the fluid is put into the subcritical state or the supercritical state after being supplied as described above, a temperature of the fluid to be supplied is preferably equal to or higher than a temperature of the melt-plasticized thermoplastic resin in the fluid supplier 13.

Therefore, the fluid supplier 13 is preferably provided with a heating means that can put the fluid to be supplied into a predetermined heated state. For example, FIG. 1 shows a diagram in which the fluid supplier 13 is connected to a heated-water production apparatus 13a. It is sufficient to produce the fluid of the predetermined heated state by using the heated-water production apparatus 13a as described above, and then, supply the resultant fluid from the fluid supplier 13 into the cylinder 12 through a pipe by using a pump such as a plunger pump.

The extruder 14 is a member that discharges, to the outside of the decomposition apparatus 10, the decomposed of the thermoplastic resin transported through the cylinder 12, and has a hole for extrusion or an extrusion opening aperture. The extruder 14 may be configured to allow the decomposed product to be discharged to the outside while maintaining the pressure in the apparatus.

Note that the extruder 14 may be connected to a container for collecting the raw material, or may be connected to a different process apparatus so that the extruded decomposed product of the thermoplastic resin is further subjected to a predetermined process.

The rotary drive mechanism 15 is an apparatus for rotating the screw 12a provided inside the cylinder 12. The thermoplastic resin to be decomposed is transported through the cylinder 12 by the screw rotated by the rotary drive mechanism 15.

Note that either a twin-screw extruder provided with two screws in the cylinder 12 or a single-screw extruder provided with a single screw is applicable. In the case of the twin-screw extruder, the two screws are rotated while being in parallel with each other. The two shafts may be disposed to mesh with or not to mesh with each other. When the number of screws is two, the twin screw with two screws is more preferable than the single screw with one screw if a screw bore diameter is the same, because of causing the high extrusion amount due to the high transportation efficiency of the raw material and the high kneading performance. Also, an extending direction of the cylinder 12 is the same as an extending direction of the screw(s) inside the cylinder 12.

The backflow suppression mechanism 16 is a mechanism for suppressing the backflow in the cylinder 12 described above which is the spout of the supplied thermoplastic resin or the melt-plasticized thermoplastic resin from the resin supplier 11 side.

In the present embodiment, the backflow suppression mechanism 16 is configured to include: at least one measurement sensor 16a selected from a resin thermometer, a resin pressure gauge, and a cylinder thermometer; a relief valve 16b provided in the cylinder 12; and a controller 16c controlling an operation of the relief valve 16b in accordance with a measured value provided by the measurement sensor 16a. Here, the measurement sensor 16a may include a screw measuring meter (not illustrated) that measures an energy consumption of the rotary drive mechanism 15 that drives the screw and/or a rotary torque of the rotary drive mechanism 15.

As described above, the measurement sensor 16a is at least one measurement sensor selected from the resin thermometer, the resin pressure gauge, the cylinder thermometer and the screw measuring meter. The measurement sensor 16a may be one of the resin thermometer, the resin pressure gauge, the cylinder thermometer and the screw measuring meter, or may be made of combination of a plurality of them. Also, although FIG. 1 shows an example of a single measurement sensor 16a, a plurality of measurement sensors of the same type may be provided. If the plurality of measurement sensors are to be provided, it is preferable to provide each of them for a different cylinder block among the cylinder blocks configuring the cylinder 12. Note that the screw measuring meter if provided as the measurement sensor 16a is not necessary to be provided for the cylinder block, and is provided so that the energy consumption and/or the rotary torque of the rotary drive mechanism 15 can be measured.

The relief valve 16b is an open/close valve capable of, at an optional timing, opening/closing the relief hole 12c connecting the inside of the cylinder 12 to the external atmosphere. The relief valve 16b may be opened and closed manually or may be opened and closed automatically. By opening the relief valve 16b, the pressure in the cylinder 12 can be decreased, and the backflow can be effectively suppressed. Note that FIG. 1 shows a configuration example in which the controller 16c is provided so as to open/close the relief valve 16b automatically. By such a configuration, the relief valve 16b can be opened immediately when a predetermined measurement value is detected, and the backflow suppression operation can be performed without delay.

The relief valve 16b is provided so as to be disposed in a region of the cylinder 12, the region being a subsequent region of a region where the melt-plasticized thermoplastic resin is formed, and its disposed position is preferably closer to the extruder 14 side (downstream side) than the fluid supplier 13, and is more preferably closer to the extruder 14 while being between the fluid supplier 13 and the extruder 14, and is particularly preferably at the cylinder block adjacent to the extruder 14.

The controller 16c is connected to the measurement sensor 16a and the relief valve 16b, and constantly monitors the temperature or pressure measured by the measurement sensor 16a. If the measured value exceeds a predetermined threshold value or if the rate of change in the measured value exceeds a predetermined magnitude, the controller 16c operates to automatically open the relief valve 16b to discharge the melt-plasticized resin in the cylinder 12 to the outside of the apparatus.

The backflow suppression mechanism 16 may be configured to monitor the measured value of the measurement sensor 16a and issue a warning if the predetermined measurement value is detected, and then, open the relief valve 16b manually when the warning is issued. In this case, the controller 16c may not be provided.

### Decomposition Method for Resin

Next, each step of the decomposition method for resin in the present embodiment will be described while exemplifying the case of using the above-described decomposition apparatus for resin 10 in FIG. 1.

First, the thermoplastic resin is supplied from the resin supplier 11 to the cylinder 12 (step (a): resin supply step). In this step, the thermoplastic resin to be decomposed is supplied into the cylinder 12 which is the body of the decomposition apparatus.

Note that the resin product to be decomposed and supplied here is not particularly limited as long as it is made of thermoplastic resin and is hydrolyzed. As the types of resins, for example, polyamide (PA) resin, polycarbonate (PC) resin, polyethylene terephthalate (PET) resin, polybutylene terephthalate (PBT) resin or the like is exemplified. In the present embodiment, an example of the hydrolyzation of the polyamide (PA) resin will be discussed.

Next, the supplied thermoplastic resin is heated and pressurized in the cylinder 12, and is melt-plasticized (step (b): melt-plasticization step). Here, the thermoplastic resin supplied in the above resin supply step is heated and pressurized while being transported in the cylinder 12 toward the extruder 15 by the screw 12a.

Here, the thermoplastic resin is gradually heated to a high temperature by the heater provided on the outer circumference of cylinder 12 while being transported, and the thermoplastic resin is gradually pressurized by the screw in the cylinder 12 while being transported. The thermoplastic resin that is melt-plasticized by the heating and the pressurization as described above can be easily transported by the screw 12a.

Although depending on the resin type to be used, it is preferable to heat and pressurize the thermoplastic resin under conditions of, for example, the resin temperature that is 250° C. to 400° C. and the resin pressure that is 15 to 22 MPa before the fluid supply step described next. By immediately before the fluid supply step, the conditions preferably reach 150 to 250° C. and 15 to 20 MPa. More specifically, if the polyamide (PA) resin is included as the resin to be decomposed, for example, the resin temperature preferably reaches 300° C. to 350° C., and the resin pressure preferably reaches 15 to 18 MPa.

Next, the heated and pressurized fluid is supplied from the fluid supplier 13 to the melt-plasticized thermoplastic resin in the cylinder 12 (step (c): fluid supply step). The fluid supplied here is mixed with the melt-plasticized thermoplastic resin.

The fluid supplied at this time to be exemplified is a fluid such as water or alcohol such as methanol that can be put into the subcritical state or the supercritical state in order to decompose the melt-plasticized resin, and water is preferable. The supercritical state indicates a state with activity that is an intermediate state between liquid and gas in a region beyond the critical point of the liquid, while the subcritical state indicates a liquid phase state with activity in a slightly lower region than that of the supercritical state.

The conditions for the subcritical state and supercritical state vary depending on the fluid to be used. In the case of water, for the subcritical state, for example, the pressure is enough to be equal to or higher than the saturation pressure at 150 to 350° C. (such as the saturation pressure of 8.59 MPa at 300° C., or the saturation pressure of 16.54 MPa at 350° C.). For the supercritical state, for example, the temperature is enough to be equal to or higher than 374° C., and the pressure is enough to be equal to or higher than 22 MPa.

Here, the fluid may be put into the subcritical state or the supercritical state even before or after being supplied to the melt-plasticized thermoplastic resin. In this fluid supply step, the heating and pressurization states are adjusted so that the fluid to be supplied meets the desired conditions. Note that it is preferable to put the fluid into the subcritical state or the supercritical state before being supplied thereto, and then, to supply the fluid into the cylinder 12. In this manner, by the supply of the fluid into the cylinder 12, the melt-plasticized thermoplastic resin is mixed with the fluid, and the decomposition can be started at the same time as the mixing.

Then, after the supply of the fluid, the thermoplastic resin melt-plasticized in the cylinder 12 is mixed with the fluid of the subcritical state or the supercritical state, and therefore, is decomposed (step (d): decomposition step). This decomposition step is preferably performed for a time period during which the thermoplastic resin is sufficiently decomposed, and, as for this, the time of mixing with the fluid of the subcritical state or the supercritical state can be adjusted by a length of the cylinder 12 and a transporting speed caused by a rotation of the screw 12a or the like.

The time period for the above decomposition is, for example, preferably 2 to 5 minutes, more preferably 5 to 10 minutes, and even more preferably 10 to 15 minutes.

The thermoplastic resin exposed to the subcritical state or the supercritical state as described above is cut at its bond, and then, becomes the decomposed product of the resin that has been decomposed (depolymerized) to be a monomer that is the raw material.

Then, the decomposed product of the thermoplastic resin obtained in the decomposition step is extruded from the extruder 14 provided at the tip of the cylinder 12 (step (e): extrusion step). The decomposed and extruded resin product is collected. This decomposed product can be reused as the raw material upon the manufacturing of resin.

Note that, in reuse, it is preferable to remove impurities contained in the decomposed product, and an impurity removal step may be performed upon the collection.

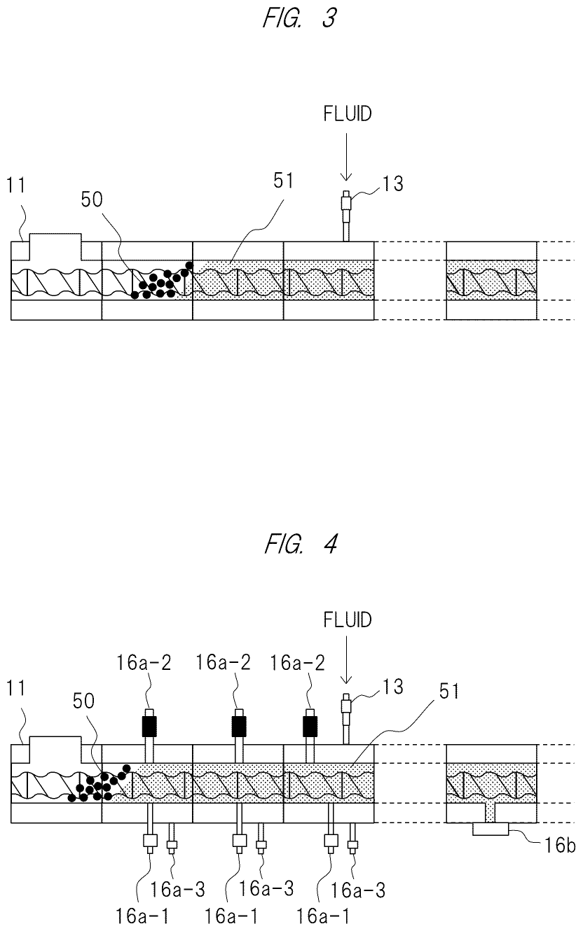

Next, the backflow suppression step that is a distinction of the present embodiment will be explained. In the steps (a) through (e) above to be performed, the thermoplastic resin fed into the cylinder 12 has, for example, a granular pellet form so as to be easily handled, and then, is heated and pressurized and then is melt-plasticized as described above after the feeding. At this time, as shown in FIG. 3, a solid pellet 50 supplied from the resin supplier 11 becomes semi-melted while being transported to the downstream side, and then, becomes the fully-melted molten resin 51.

At this time, if the pressure on the pellet 50 side and the pressure on the molten resin 51 side are balanced, the operation can be continued, and the decomposition can be performed efficiently. However, if this balance is lost to increase the pressure on the molten resin 51 side to be higher than the pressure on the pellet 50 side, the molten resin 51 flows back while pushing the pellet 50 back toward the resin supplier 11, and finally, the molten resin 51 and the pellet 50 in the mixed state may spout out of the resin supplier 11.

In the present embodiment, in order to suppress such a backflow, the cylinder 12 includes the measurement sensor 16a as shown in FIG. 1. FIG. 3 shows an example in which this measurement sensor 16a is a resin thermometer 16a-1, a resin pressure gauge 16a-2 and a cylinder thermometer 16a-3. However, as described above, the measurement sensor 16a may be made of one, two or three types of them. Alternatively, the measurement sensor 16a may be made of the single screw measuring meter (in this case, the screw measuring meter is provided to the rotary drive apparatus 15), or may be made of a combination of the screw measuring meter with at least one type of the resin thermometer 16a-1, the resin pressure gauge 16a-2 and the cylinder thermometer 16a-3. The following explanation will be made with reference to FIG. 3 in which the measurement sensor 16a is provided to the cylinder block.

Here, FIG. 3 shows an example in which the cylinder blocks in the cylinder 12 between the resin supplier 11 and the fluid supplier 13 may be provided with the resin thermometer 16a-1, the resin pressure gauge 16a-2, and the cylinder thermometer 16a-3. However, the measurement sensor may be provided to single cylinder block.

Even if the measurement sensor is provided to the single cylinder block, when the measurement sensor 16a is provided, the pressure unbalance can be detected, and therefore, there is no problem. And, if the measurement sensor is provided to a plurality of cylinder blocks, the pressure unbalance can be more accurately detected, and therefore, this is preferable.

As the cylinder block provided with the measurement sensor 16a, note that the cylinder block on the resin supplier 11 side, mostly including the pellet, is preferably provided therewith. In this manner, if the cylinder block on the resin supplier 11 side has a change in the numerical value measured by the measurement sensor 16a, the occurrence of the backflow can be accurately detected, and then, a suppression operation described later can be started.

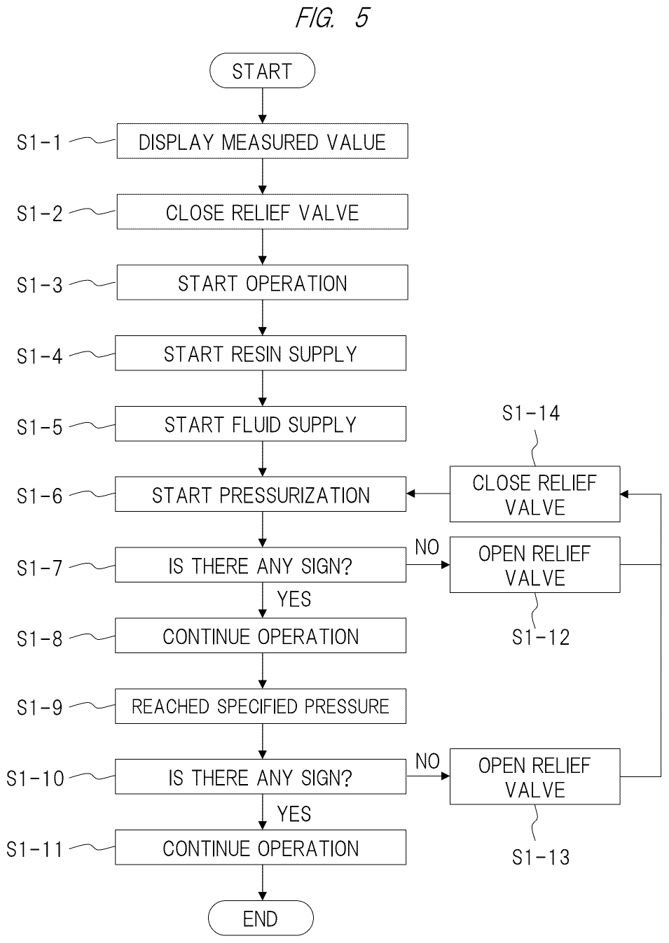

For example, when the decomposition is continued in the state shown in FIG. 3 but the pressure on the molten resin 51 side increases to start the backflow of the molten resin toward the resin supplier 11 side as shown in FIG. 4, the change in the value measured by at least one of the resin thermometer 16a-1, the resin pressure gauge 16a-2, and the cylinder thermometer 16a-3 is detected. If the occurrence of the backflow is confirmed, the controller 16c opens the relief valve 16b to discharge the molten resin 51 from the inside of the cylinder 12 to the outside through an opening. By this, the pressure of the molten resin inside the cylinder 12 is decreased, thereby suppressing a situation of the backflow and the spout of the molten resin 51 together with the pellet 50 toward the resin supplier 11 side. As a specific example, the relief valve 16b is opened when the temperature increase of 10% is observed so that the resin thermometer 16a-1 indicates the temperature from, for example, 240°° C. to 265° C.

Note that, for the value measured by the measurement sensor 16a, in order to control the operation of the relief valve 16b by the controller 16c, a threshold value based on the measured value may be set, or a threshold value based on the changed value obtained by monitoring its temporal change may be set. This threshold value may be appropriately set depending on the cylinder provided with the measurement sensor 16a, the resin or fluid to be used, the conditions for decomposition or the like.

In the case of the decomposition using polyamide resin as the thermoplastic resin to be decomposed and water as the fluid to be supplied, as the threshold value based on the measured value to be exemplified, for example, 50 to 225° C. may be set for the resin temperature, 1 to 8 MPa may be set for the resin pressure, and 25 to 250° C. may be set for the cylinder temperature. As the threshold value based on the changed value to be exemplified, for example, 5 to 30% may be set for the resin temperature, 5 to 30% may be set for the resin pressure, and 5 to 30% may be set for the cylinder pressure.

### Operation of Decomposition Apparatus

The decomposition apparatus and the decomposition method for resin according to the present embodiment have been explained above. A series of operations of the decomposition apparatus for resin 10 will be explained with reference to the flowchart in FIG. 5.

First, the decomposition apparatus for resin 10 is activated, and the values (of the temperature and the pressure) measured by the measurement sensor 16a are displayed (S1-1). Then, the relief valve 16b is closed (S1-2), and the operation of the decomposition apparatus 10 is started (S1-3). By the start of the operation, the cylinder 12 is heated to a predetermined temperature, and the driving of the screw 12a is also started.

The supply of the pellet 50 as the resin to be decomposed to the resin supplier 11 is started (S1-4). After confirming the sufficient resin melting/plasticization and the transportation in the cylinder 12, the supply of the heated and pressurized fluid from the fluid supplier 13 is started (S1-5).

Furthermore, the pressurization is started to set the pressure in the cylinder 12 to a predetermined pressure (S1-6). At the same time with the start of the pressurization, it is confirmed based on the value measured by the measurement sensor 16a whether there is any backflow sign (S1-7). If there is no backflow sign, the operation is continued (S1-8). Then, it is confirmed that the pressure has reached the specified pressure (S1-9), and it is confirmed again based on the value measured by the measurement sensor 16a whether there is any backflow sign (S1-10). If there is no backflow sign even in this case, the operation is continued to continue the resin decomposition (S1-11).

To the contrary, when it is confirmed whether there is any backflow sign as described above (S1-7, S1-10), if there is any backflow sign, the relief valve 16 is opened (S1-12, S1-13). By the open of the relief valve 16, the pressure inside the cylinder 12 can be rapidly decreased, and the backflow can be suppressed (prevented). Also, when it is constantly confirmed whether there is any backflow sign even after the operation is continued (S1-11), the backflow can be reliably suppressed (prevented).

If it is desired that the operation is restarted after the open of the relief valve 16, the relief valve 16 is closed (S1-14), and the pressurization is started again (S1-6), and the operation is performed while it is confirmed whether there is any backflow sign (S1-7 to S1-14). Once the relief valve 16 is opened, note that the operation is preferably restarted after removing a cause of the backflow, if any.

If there is no problem, the operation is still continued until the end of all the decompositions for resin. At the time of the end of all, the decomposition apparatus is stopped.

### Second Embodiment

### Apparatus of Manufacturing Resin Composite

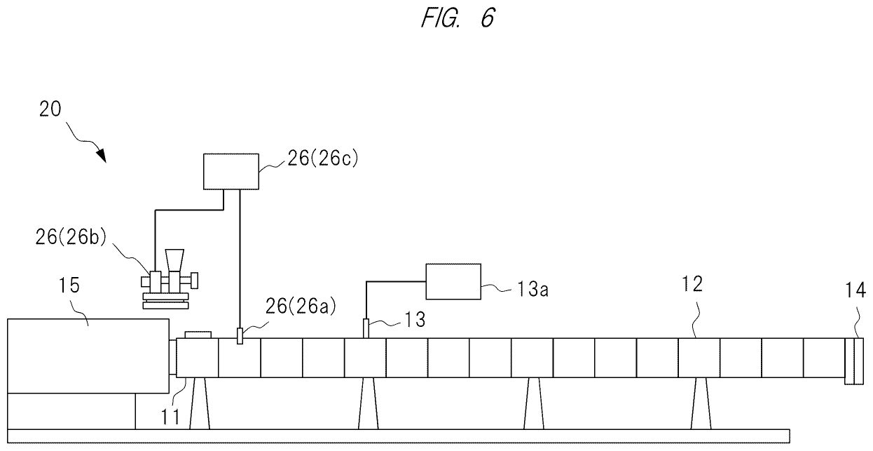

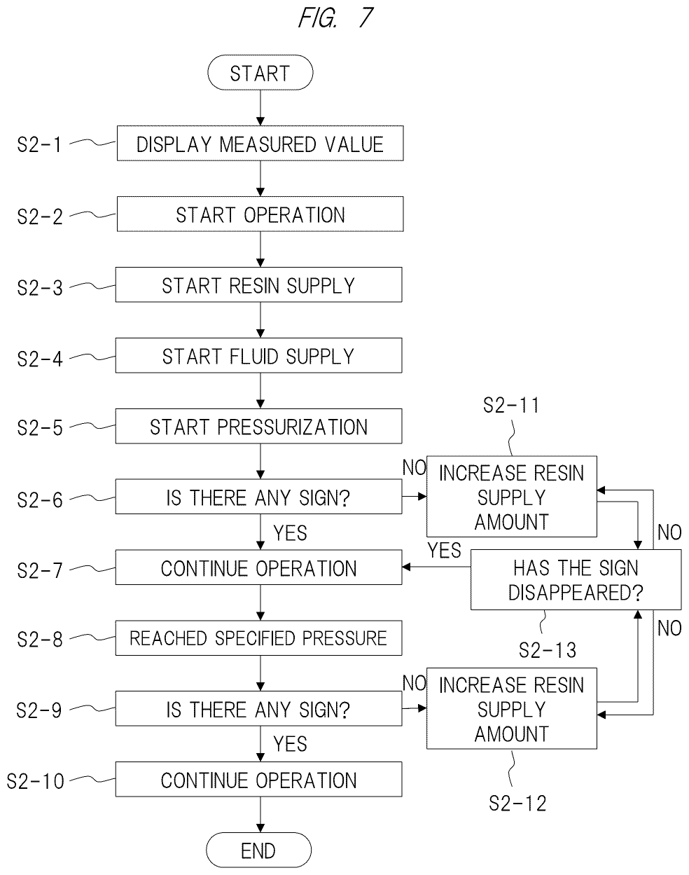

The second embodiment is an embodiment of suppressing the backflow by changing in an amount of the resin supplied from the resin supplier as the backflow suppression mechanism, and its other configurations can be the same with those of the first embodiment. FIG. 6 is a diagram showing a configuration example of a decomposition apparatus for resin in the second embodiment.

A decomposition apparatus for resin 20 shown in FIG. 6 includes the resin supplier 11, the cylinder 12 with the screw, the fluid supplier 13 supplying the fluid to the cylinder 12, the extruder 14, the rotary drive mechanism 15 driving the screw of the cylinder 12, and a backflow suppression mechanism 26.

Here, the resin supplier 11, the cylinder 12, the fluid supplier 13, the extruder 14, and the rotary drive mechanism 15 are the same in the contents with those described in the first embodiment, and therefore, the description thereof is omitted. The second embodiment is configured to suppress the backflow by the change in the amount of the resin supplied from the resin supplier 11 as described above, and has a distinction in the backflow suppression mechanism 26. The backflow suppression mechanism 26 will be explained in detail below.

In the present embodiment, the backflow suppression mechanism 26 is configured to include: at least one measurement sensor 26a selected from a resin thermometer, a resin pressure gauge, and a cylinder thermometer; a feeder 26b capable of adjusting the amount of resin supplied to the resin supplier 11; and a controller 26c controlling the operation of the feeder 26b in accordance with the measured value obtained by the measurement sensor 26a.

The configuration of the measurement sensor 26a can be made the same with that of the measurement sensor 16a described in the first embodiment, and therefore, the description thereof is omitted here.

A publicly-known feeder can be used as the feeder 26b, and the feeder 26b is an apparatus that supplies the resin to be decomposed to the resin supplier 11. The feeder 26b used in this embodiment has a function to adjust the supply amount, and is connected to the controller 26c described next, and can change the resin amount to be supplied, in accordance with the situation.

The controller 26c is connected to the measurement sensor 26a and the feeder 26b, and constantly monitors the temperature or the pressure measured by the measurement sensor 26a. When the measured value exceeds a predetermined threshold value or when a rate of the change in the measured value exceeds a predetermined magnitude, the controller 26c operates to increase the amount of resin supplied from the feeder 26b to the resin supplier 11.

Regarding the backflow suppression mechanism 26, it may be set that the value measured by the measurement sensor 26a is monitored, it may be set that a warning is issued when a predetermined measurement value is detected, and the amount of resin supplied from the feeder may be increased manually when the warning is issued. In this case, the controller 26c may not be provided.

### Decomposition Method for Resin

Next, each step of the decomposition method for resin in the present embodiment will be described while exemplifying the case of using the above-described decomposition apparatus for resin 20 in FIG. 6.

Note that the steps (a) through (e) of the decomposition method for resin in the present embodiment are common with those of the decomposition method for resin described in the first embodiment, and therefore, the description thereof is omitted. Since the distinction of the present embodiment is the backflow suppression step that is different from that of the first embodiment, and therefore, this difference will be mainly explained below.

In the steps (a) through (e) above to be performed, as explained in the first embodiment and FIG. 3, the solid pellet 50 supplied from the resin supplier 11 becomes semi-melted while being transported to the downstream side, and then, becomes the fully-melted molten resin 51. Then, if the balance between the pressure on the pellet 50 side and the pressure on the molten resin 51 side is lost, the molten resin 51 flows back while pushing the pellet 50 back toward the resin supplier 11, and finally, the molten resin 51 and the pellet 50 in the mixed state may spout out of the resin supplier 11.

In the present embodiment, in order to suppress such a backflow, the cylinder 12 includes at least one measurement sensor 26a selected from a resin thermometer, a resin pressure gauge, and a cylinder thermometer, as shown in FIG. 6. This measurement sensor 26a can be configured to have the same configuration as that of the measurement sensor 16a of the first embodiment.

In the present embodiment, when the decomposition is continued in the state shown in FIG. 3 but the pressure on the molten resin 51 side increases to start the backflow of the molten resin toward the resin supplier 11 side as shown in FIG. 4, the change in the value measured by at least one of the resin thermometer 16a-1, the resin pressure gauge 16a-2, and the cylinder thermometer 16a-3 is detected. If the occurrence of the backflow is confirmed, the controller 26c increases the resin supply amount in the feeder 26b to increase the pressure on the molten resin 51 side. By this, the balance between the pressures of the pellet 50 and the molten resin 51 inside the cylinder 12 is adjusted, thereby suppressing a situation of the backflow and the spout of the molten resin 51 together with the pellet 50 toward the resin supplier 11 side.

In this case, for the value measured by the measurement sensor 26a, the threshold value or the changed value explained in the first embodiment may be set, and the apparatus may be operated.

Note that the increased resin amount is sufficient to be an amount that can suppress the spout due to the backflow, and, for example, the amount is preferably 1.5 to 2.5 times the originally supplied resin amount.

Also, after increasing the resin amount, the value measured by the measurement sensor 26a is confirmed again to confirm whether the backflow has been suppressed. If the backflow has not been suppressed, the resin amount may be further increased, and these steps may be repeated until the backflow is suppressed. In this case, as the increased resin amount, the resin amount may be gradually increased to reach about 1.1 to 1.5 times the originally supplied resin amount.

### Operation of Decomposition Apparatus

The decomposition apparatus and the decomposition method for resin according to the present embodiment have been explained above. A series of operations of the decomposition apparatus for resin 20 will be explained with reference to the flowchart in FIG. 7.

First, the decomposition apparatus for resin 20 is activated, and the values (of the temperature and the pressure) measured by the measurement sensor 26a are displayed (S2-1). Then, the operation of the decomposition apparatus 20 is started (S2-2). By the start of the operation, the cylinder 12 is heated to a predetermined temperature, and the driving of the screw 12a is also started.

The supply of the pellet 50 as the resin to be decomposed to the resin supplier 11 is started (S2-3). After confirming the sufficient resin melting/plasticization and the transportation in the cylinder 12, the supply of the heated and pressurized fluid from the fluid supplier 13 is started (S2-4).

Furthermore, the pressurization is started to set the pressure in the cylinder 12 to a predetermined pressure (S2-5). At the same time with the start of the pressurization, it is confirmed based on the value measured by the measurement sensor 26a whether there is any backflow sign (S2-6). If there is no backflow sign, the operation is continued (S2-7).

Then, it is confirmed that the pressure has reached the specified pressure (S2-8), and it is confirmed again based on the value measured by the measurement sensor 26a whether there is any backflow sign (S2-9). If there is no backflow sign even in this case, the operation is continued to continue the resin decomposition (S2-10).

To the contrary, when it is confirmed whether there is any backflow sign as described above (S2-6, S2-9), if there is any backflow sign, the amount of resin supplied from the feeder 26b is increased (S2-11, S2-12). After the increase in the supplied resin amount, the value measured by the measurement sensor 26a is confirmed, and it is confirmed whether the sign has disappeared (S2-13). If the sign has disappeared, the operation is continued to continue the resin decomposition (S2-10). If the sign has not disappeared, the resin amount is increased again (S2-11, S2-12), and these steps are repeated until the sign disappears. By the increase in the supplied resin amount, the balance between the pressures of the pellet 50 and the molten resin 51 inside the cylinder 12 is adjusted, thereby suppressing (preventing) the backflow. When it is constantly confirmed whether there is no backflow sign even after the operation is continued (S2-10), the backflow can be reliably suppressed (prevented).

If there is no problem, the operation is still continued until the end of all the decompositions for resin. At the time of the end of all, the decomposition apparatus is stopped.

### Third Embodiment

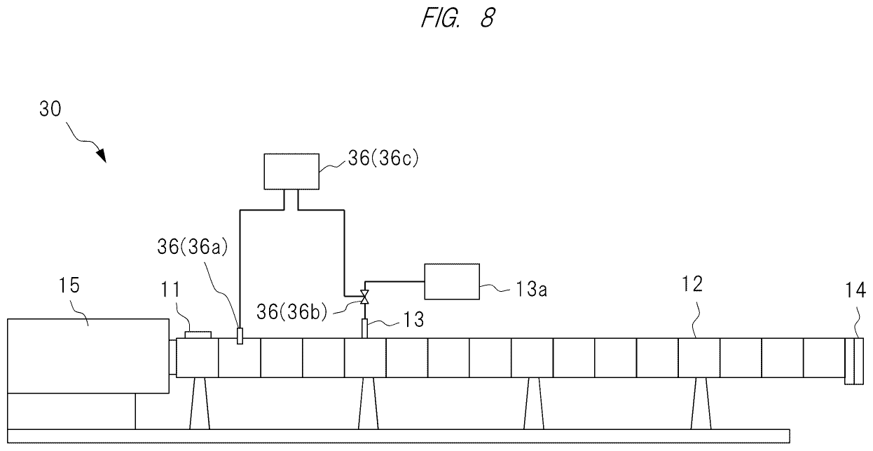

The third embodiment is an embodiment of suppressing the backflow by stopping the fluid supply from the fluid supplier as the backflow suppression mechanism, and its other configurations can be the same with those of the first embodiment. FIG. 8 is a diagram showing a configuration example of a decomposition apparatus for resin in the third embodiment.

A decomposition apparatus for resin 30 shown in FIG. 8 includes the resin supplier 11, the cylinder 12 with the screw, the fluid supplier 13 supplying the fluid to the cylinder 12, the extruder 14, the rotary drive mechanism 15 driving the screw of the cylinder 12, and a backflow suppression mechanism 36.

Here, the resin supplier 11, the cylinder 12, the fluid supplier 13, the extruder 14, and the rotary drive mechanism 15 are the same in the contents with those described in the first embodiment, and therefore, the description thereof is omitted. The third embodiment is configured to suppress the backflow by stopping the fluid supply from the fluid supplier 13 as described above, and has a distinction in the backflow suppression mechanism 36. The backflow suppression mechanism 36 will be explained in detail below.

In the present embodiment, the backflow suppression mechanism 36 is configured to include: at least one measurement sensor 36a selected from a resin thermometer, a resin pressure gauge, and a cylinder thermometer; a valve 36b connected to the fluid supplier 13 and disposed on a pipe for supplying the fluid; and a controller 36c capable of controlling the open/close of the valve 36b in accordance with the measured value obtained by the measurement sensor 36a.

The configuration of the measurement sensor 36a can be made the same with that of the measurement sensor 16a described in the first embodiment, and therefore, the description thereof is omitted here.

A publicly-known valve can be used as the valve 36b, and the valve 36b is disposed on the pipe connected for supplying the fluid from the fluid supplier 13 to the cylinder 12. By the open/close of the valve 36b, decision of whether to supply the fluid to the cylinder and the supply amount can be controlled.

The controller 36c is connected to the measurement sensor 36a and the valve 36b, and constantly monitors the temperature or the pressure measured by the measurement sensor 36a. When the measured value exceeds a predetermined threshold value or when a rate of the change in the measured value exceeds a predetermined magnitude, the controller 36c operates to close the valve 36b, thereby stopping the fluid supply to the cylinder 12.

Regarding the backflow suppression mechanism 36, it may be set that the value measured by the measurement sensor 36a is monitored, it may be set that a warning is issued when a predetermined measurement value is detected, and the fluid supply from the fluid supplier 13 may be stopped manually when the warning is issued. In this case, the controller 36c may not be provided.

### Decomposition Method for Resin

Next, each step of the decomposition method for resin in the present embodiment will be described while exemplifying the case of using the above-described decomposition apparatus for resin 30 in FIG. 8.

Note that the steps (a) through (e) of the decomposition method for resin in the present embodiment are common with those of the decomposition method for resin described in the first embodiment, and therefore, the description thereof is omitted. Since the distinction of the present embodiment is the backflow suppression step that is different from that of the first embodiment, and therefore, this difference will be mainly explained below.

In the steps (a) through (e) above to be performed, as explained in the first embodiment and FIG. 3, the solid pellet 50 supplied from the resin supplier 11 becomes semi-melted while being transported to the downstream side, and then, becomes the fully-melted molten resin 51. Then, if the balance between the pressure on the pellet 50 side and the pressure on the molten resin 51 side is lost, the molten resin 51 flows back while pushing the pellet 50 back toward the resin supplier 11, and finally, the molten resin 51 and the pellet 50 in the mixed state may spout out of the resin supplier 11.

In the present embodiment, in order to suppress such a backflow, the cylinder 12 includes at least one measurement sensor 36a selected from a resin thermometer, a resin pressure gauge, and a cylinder thermometer, as shown in FIG. 8. This measurement sensor 36a can configured to have the same configuration as that of the measurement sensor 16a of the first embodiment.

In the present embodiment, when the decomposition is continued in the state shown in FIG. 3 but the pressure on the molten resin 51 side increases to start the backflow of the molten resin toward the resin supplier 11 side as shown in FIG. 4, the change in the value measured by at least one of the resin thermometer 16a-1, the resin pressure gauge 16a-2, and the cylinder thermometer 16a-3 is detected. If the occurrence of the backflow is confirmed, the controller 36c closes the valve 36b, thereby stopping the fluid supply to the cylinder 12. By this, the balance between the pressures of the pellet 50 and the molten resin 51 inside the cylinder 12 is adjusted, thereby suppressing a situation of the backflow and the spout of the molten resin 51 together with the pellet 50 toward the resin supplier 11 side.

In this case, for the value measured by the measurement sensor 36a, the threshold value or the changed value as explained in the first embodiment may be set, and the apparatus may be operated.

### Operation of Decomposition Apparatus

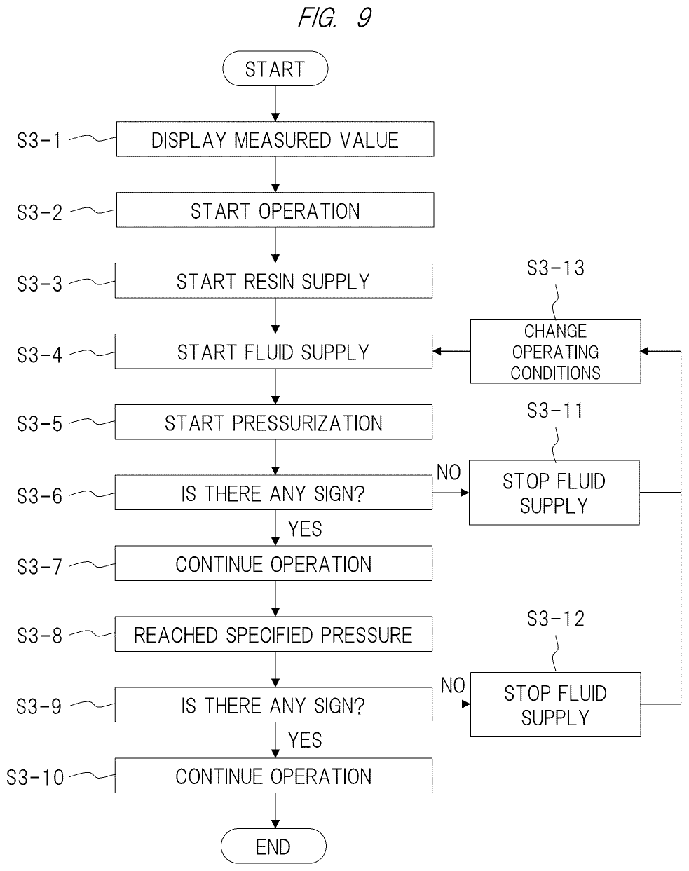

The decomposition apparatus and the decomposition method for resin according to the present embodiment have been explained above. A series of operations of the decomposition apparatus for resin 30 will be explained with reference to the flowchart in FIG. 9.

First, the decomposition apparatus for resin 30 is activated, and the values (of the temperature and the pressure) measured by the measurement sensor 36a are displayed (S3-1). Then, the operation of the decomposition apparatus 30 is started (S3-2). By the start of the operation, the cylinder 12 is heated to a predetermined temperature, and the driving of the screw 12a is also started.

The supply of the pellet 50 as the resin to be decomposed to the resin supplier 11 is started (S3-3). After confirming the sufficient resin melting/plasticization and the transportation in the cylinder 12, the supply of the heated and pressurized fluid from the fluid supplier 13 is started (S3-4).

Furthermore, the pressurization is started to set the pressure in the cylinder 12 to a predetermined pressure (S3-5). At the same time with the start of the pressurization, it is confirmed based on the value measured by the measurement sensor 36a whether there is any backflow sign (S3-6). If there is no backflow sign, the operation is continued (S3-7).

Then, it is confirmed that the pressure has reached the specified pressure (S3-8), and it is confirmed again based on the value measured by the measurement sensor 36a whether there is any backflow sign (S3-9). If there is no backflow sign even in this case, the operation is continued to continue the resin decomposition (S3-10).

To the contrary, when it is confirmed whether there is any backflow sign as described above (S3-6, S3-9), if there is any backflow sign, the valve 36b is closed, thereby stopping the fluid supply from the fluid supplier 13 (S3-11, S3-12). After the stop of the fluid supply, the operation conditions are changed (S3-13). The operation conditions to be changed in this case are only necessary to be conditions capable of suppressing the backflow, and, for example, the resin supply amount, the fluid supply amount, the screw rotation speed, the cylinder temperature or the like is exemplified.

After the change of the operation conditions, the valve 36b is opened, thereby restarting the fluid supply (S3-4). By the stop of the fluid supply, the balance between the pressures of the pellet 50 and the molten resin 51 inside the cylinder 12 is adjusted, thereby suppressing (preventing) the backflow. When it is constantly confirmed whether there is no backflow sign even after the operation is continued (S3-10), the backflow can be reliably suppressed (prevented).

If there is no problem, the operation is still continued until the end of all the decompositions for resin. At the time of the end of all, the decomposition apparatus is stopped.

In the foregoing, the present invention has been concretely described with reference to the embodiments and the examples. However, it is needless to say that the present invention is not limited to the foregoing embodiments, and various modifications can be made within the scope of the present invention.

### EXPLANATION OF REFERENCE CHARACTERS

10, 20, 30 Decomposition apparatus for resin
11 Resin supplier
12 Cylinder
12a Screw
12b Fluid supply hole
12c Relief hole
13 Fluid supplier
14 Extruder
15 Rotary drive mechanism
16, 26, 36 Backflow suppression mechanism
16a, 26a, 36a Measurement sensor
16c, 26c, 36c Controller
16b Relief valve
26b Feeder
36c Valve

1. A decomposition method for resin, comprising steps of:
(a) supplying a thermoplastic resin from a resin supplier to a cylinder;
(b) heating and pressurizing and then melt-plasticizing the supplied thermoplastic resin in the cylinder;
(c) supplying a heated and pressurized fluid from a fluid supplier to the melt-plasticized thermoplastic resin, and mixing the fluid with the thermoplastic resin;
(d) decomposing the melt-plasticized thermoplastic resin by exposing the thermoplastic resin to a subcritical state or a supercritical state by the supplied fluid; and
(e) extruding a decomposed product of the thermoplastic resin obtained in the step (d) from an extruder provided at a tip of the cylinder,
wherein, in the step (b), a backflow suppression step of measuring at least one selected from a temperature of the thermoplastic resin, a pressure of the thermoplastic resin and a temperature of the cylinder, and then, suppressing the backflow of the melt-plasticized thermoplastic resin in accordance with the measured value is performed.

2. The decomposition method for resin according to claim 1,
wherein the backflow suppression step is a step of discharging the melt-plasticized thermoplastic resin from the cylinder to outside, in the cylinder closer to a downstream side than the fluid supplier.

3. The decomposition method for resin according to claim 2,
wherein the molten resin is discharged to outside through a relief hole provided in the cylinder adjacent to the extruder.

4. The decomposition method for resin according to claim 1,
wherein the backflow suppression step is a step of increasing a supply amount of the thermoplastic resin in the step (a).

5. The decomposition method for resin according to claim 4,
wherein the supply amount of the thermoplastic resin increases by 1.5 to 2.5 times.

6. The decomposition method for resin according to claim 1,
wherein the backflow suppression step is a step of stopping supply of the fluid in the step (c).

7. The decomposition method for resin according to claim 1,
wherein the thermoplastic resin is a polyamide resin.

8. A decomposition apparatus for resin, comprising:
a cylinder;
a resin supplier supplying a thermoplastic resin to be decomposed, to the cylinder;
a screw transporting the supplied thermoplastic resin and the melt-plasticized thermoplastic resin in the cylinder;
a fluid supplier supplying a heated and pressurized fluid into the cylinder in order to decompose the melt-plasticized thermoplastic resin in a subcritical state or a supercritical state;
an extruder provided at a tip of the cylinder and extruding a decomposed product of the thermoplastic resin to outside of the cylinder; and
a backflow suppression mechanism including, in the cylinder provided between the resin supplier and the fluid supplier, at least one selected from a resin thermometer for measuring a temperature of the thermoplastic resin, a resin pressure gauge for measuring a pressure of the thermoplastic resin, a cylinder thermometer for measuring a temperature of the cylinder, and a screw measuring meter for measuring an energy consumption or a drive torque of a rotary drive mechanism driving the screw, the backflow suppression mechanism capable of suppressing the backflow of the melt-plasticized thermoplastic resin in accordance with at least one of the measured values of the resin thermometer, the resin pressure gauge, the cylinder thermometer, and the screw measuring meter.

9. The decomposition apparatus for resin according to claim 8,
wherein the backflow suppression mechanism includes, in the cylinder closer to a downstream side than the fluid supplier:
a relief valve provided to open/close a relief hole for connecting inside of the cylinder and external atmosphere; and
a controller controlling the open/close of the relief valve in accordance with the measured value(s).

10. The decomposition apparatus for resin according to claim 9,
wherein the relief valve is provided in the cylinder adjacent to the extruder.

11. The decomposition apparatus for resin according to claim 8,
wherein the backflow suppression mechanism includes:
a feeder capable of adjusting an amount of resin supplied from the resin supplier; and
a controller increasing the amount of resin supplied from the resin supplier to the cylinder by the feeder in accordance with the measured value(s).

12. The decomposition apparatus for resin according to claim 8,
wherein the backflow suppression mechanism includes:
a valve connected to the fluid supplier and provided in a pipe for supplying the fluid; and
a controller capable of controlling open/close of the valve in accordance with the measured value(s).
